(19) United States
(12) Patent Application Publication
(10) Pub. No.: US 2010/0042830 A1
(43) Pub. Date: Feb. 18, 2010

(54) Method for Controlling a Consumption Limit Date of Digital Contents Device for Consuming Such Contents, Means of Controlling Consumption and Server Distributing Such Contents

(76) Inventors: Jiang Shao, Rennes (FR); Jean-Pierre Andreaux, Amsterdam (NL); Jean-Louis Diascorn, Betton (FR)

Correspondence Address: Robert D. Shedd, Patent Operations;THOMSON Licensing LLC, P.O. Box 5312, Princeton, NJ, 08543-5312, US

(21) Appl. No.: 11/922,447

(22) PCT Filed: Jun. 30, 2006
(86) PCT No.: PCT/EP2006/006360

§ 371 Date: Sep. 15, 2009

(30) Foreign Application Priority Data
Jun. 30, 2005 (FR) 0551841

(51) Int. Cl. H04L 9/32

(52) U.S. Cl. 713/156

(57) ABSTRACT

This invention relates to a method for controlling the consumption limit date of a digital content which is transferred from distribution means (100) to a consuming device (120) during a temporary connection to be consumed on that device until the limit date, the distribution means (100) having a clock (104), called a reference clock, the value of which at each instant is called the true date.

According to this invention, each time the consuming device connects to the distribution means (100), a signal including the true date is transmitted from the distribution means (100) to the consuming device (120) by a secured method to verify that the consumption limit date is not exceeded.

### FIELD OF THE INVENTION

The present invention relates to a method for controlling a consumption limit date on digital contents that must be consumed before this limit date, devices for consuming such contents, means for controlling this consumption and a server distributing such contents.

This invention relates in particular to the field of the controlling of digital audio and/or video content consumption rights in standalone or portable consuming devices.

### BACKGROUND OF THE INVENTION

Producers of multimedia contents (for example, and without limitation: films, documentaries, music, video clips, video games, audiovisual contents, services or other, etc.), in order to control the consumption of their production distributed by digital networks such as the Internet and to avoid piracy, use methods for controlling consumption rights, hereinafter called DRM (Digital Right Management) methods, these rights being associated with the contents sold to their customers.

A digital content can be distributed by various types of distribution. One of the best known is pay-per-view content distribution which is used in particular to distribute high added value contents (sporting events, recent films, etc.), limiting their consumption in such a way that it is possible only a predetermined number of times.

Another type of distribution is based on the association with contents of consumption rights corresponding to a period of authorized access to these contents (pay-per-time). In this context, it is essential to be able to reliably check this access time or aggregate consumption time. The contents distributed in this way are called contents with limited access time.

Without any reliable control, it is possible to defraud with impunity the registers that are used to control the content access time in the consuming device.

In certain cases, the control on consumption according to access time is normally done from content distribution means via a communication means. The content distribution means can supply a reliable reference date to the content consuming device using this communication means.

However, the permanent or regular implementation of this communication means is not always possible, particularly in the case where the consuming device is portable (for example, a portable multimedia player) or in the case of a standalone consuming device (for example, a television receiver in a second home).

### SUMMARY OF THE INVENTION

The invention therefore results from the observation that certain current consuming devices (in particular the portable and/or standalone devices) are not able to control reliably and inexpensively the content access time.

The present invention seeks to resolve the problem of reliably controlling the consumption time on contents with limited access time in consuming devices not having a permanent or regular connection to external controlling means.

The invention relates to a method for controlling the consumption limit date on a digital content which is transferred from distribution means to a consuming device during a temporary connection to be consumed on that device until the limit date, the distribution means having a clock, called a reference clock, the value of which at each instant is called the true date, characterized in that, each time the consuming device connects to the distribution means, a signal including the true date is transmitted from the distribution means to the consuming device by a secured method to verify that the consumption limit date is not exceeded.

The reference clock can be a secured clock included in the distribution means.

In this way, the consumption control is carried out by the distribution means, which allows for a sufficiently reliable control without increasing the cost of the consuming device.

The value of the allotted time is normally transmitted to the consuming device with the content, for example in the content licence.

It will be noted to this end that the concept of “date” covers any time reference, whether it is a second, minute, hour, day, month or year, or even a time reference finer than the second depending on the precision of the reference clock.

In an embodiment, in the case where the consumption limit date has been exceeded, the consumption of this content on the consuming device is blocked, or this content is erased from the consuming device.

Thus, it is in particular possible to react to fraud on the part of a user with a sanction.

Other independent sanctions can be implemented such as, for example, a fine, the removal of consumption rights of a user or the deregistration of the customer file of the content provider concerned.

According to an embodiment, the secured method of transferring the true date includes the sending of the result, called the result of external processing of the true date, a secured digital processing of this true date by the distribution means, reliable processing means of the consuming device obtaining the true date from the result of the external processing of the true date.

This secured digital processing can be, for example:
an encryption of this true date, or
the result of the implementation of an authentication and verification algorithm.

Reliable means of processing the consuming device can include in particular a secured processor.

In an embodiment, the secured method of transferring the true date includes the sending of the true date in plaintext associated with the sending of the result of the external processing of the true date and the comparison in the consuming device of this result of the external processing of the true date with the result of the secured digital processing in the consuming device of the true date received in plain language in order to guarantee its authenticity.

For example, if the secured digital processing is a given encryption method, the true date is encrypted in the distribution means and the result of this encryption is sent with the true date in plain language to the consuming device. Then, in this consuming device, the true date received in plain language is encrypted and the latter encryption is compared in the consuming device with the first result of the encryption done in the distribution means.

According to an embodiment, a microprocessor card is used, included in the consuming device to perform the encryption.

In an embodiment, the consuming device having an internal clock, the value of which at each instant is called the date of the device, this internal clock of the device is synchronized with the reference clock each time the true date is received by the device.

According to an embodiment, to enable the true date to be verified on each connection, an event file is associated with the internal clock of the consuming device, this file storing regularly sampled values of the internal clock of the consuming device or variations of the internal clock value not attributable to elapsed time.

This event file therefore records a history of the variations of the clock (either by regular sampling, or by recording deviations of the clock that do not correspond to the elapsed time).

Advantageously, this file can reveal an operating problem on the internal clock or a fraud on this internal clock.

According to an embodiment, the event file is included in a microprocessor card associated with the consuming device.

Thus, this event file is secured and cannot be manipulated by the user of the consuming device.

In an embodiment, the microprocessor card associated with the consuming device stores a time counter aggregating the consumption times of the content in order to block its consumption when the value of this counter exceeds the difference between the consumption limit date and an initial consumption date, from which the consumption of the content is authorized.

The initial consumption date can be, for example, the date of transfer of the content to the consuming device.

The invention also relates to a consuming device intended to consume at least one digital content until a limit date, this device comprising means for receiving this content transferred from distribution means having a clock, called a reference clock and the value of which at each instant is called the true date, on a temporary connection.

According to this second aspect of the invention, the device includes means for receiving, in a secured way, a signal including the true date on the temporary connection to the distribution means, this true date then being used as a time reference to control that the consumption limit date of the content is not exceeded.

This second aspect of the invention therefore relates in particular to devices that cannot be connected permanently to the distribution means, either because they are standalone (such as, for example, a television set in a second home or a video display device inside a car), that is, they cannot be connected to the distribution means regularly, or because they are portable.

In an embodiment, the consuming device includes an internal clock and means for synchronizing its internal clock with the reference clock using the true date received.

In an embodiment, the consuming device is portable and can be used to consume audio and/or video contents.

This consuming device can be, in particular, a potable multimedia player.

The invention also relates to means for controlling the consumption of a content, these means being included in distribution means to which a consuming device is connected to receive a content in order to consume it, this consumption being possible only before a limit date, the distribution means having a clock, called a reference clock.

According to this third aspect of the invention, such controlling means include means for sending in a secured way the value of the reference clock, called the true date, to the consuming device each time the consuming device is connected to the distribution means.

These controlling means can in particular implement the DRM methods of the distribution means.

This invention further relates to a server having an internal clock, called a reference clock, and distributing a digital content, the consumption of which must be completed before a limit date on a consuming device on a temporary connection of this consuming device to the server.

According to this fourth aspect of the invention, such a server includes means for sending in a secured way the value of the reference clock, called the true date, to the consuming device each time the consuming device is connected to the server, in order to control that the consumption limit date of the content is not exceeded.

In an embodiment, the server includes controlling means in accordance with the third aspect of the invention.

With this invention, it is possible to reliably control the consumption of the contents having rights based in particular on an allotted consumption time when this consumption takes place on a consuming device not having a secured clock or means of permanent or regular connection to the distribution means.

Advantageously, the control on the time allotted to the contents then depends mainly on the distribution means for which the security requirements are defined by the DRM methods used in particular by the control means specific to the invention.

The security requirements for the consuming device according to the invention are then less severe.

Finally, the invention relates to a method for controlling the consumption limit date of a digital content stored in a consuming device, the consumption limit date being contained in a license stored in a secure memory of the consuming device, wherein said method comprises:

receiving a value of a reference clock, called true date, in a message transmitted securely from distribution means;

verifying the validity of the consumption limit date contained in the license stored in the secure memory with respect to the received true date; and

should said consumption limit date be exceeded, blocking the consumption of this content on the consuming device or erasing the content from the consuming device.

### BRIEF DESCRIPTION OF THE DRAWINGS

Other characteristics and advantages of the invention will become apparent from the description given below by way of nonlimiting example, with reference to the appended figures in which:

FIG. 1a diagrammatically represents a server according to the invention connected to a consuming device according to the invention,

FIG. 1b is a diagrammatic representation of data flow between the server and the consuming device in certain steps of the method according to the invention,

FIG. 2 diagrammatically represents an embodiment of the invention,

FIG. 3 is a schematic description of an embodiment of the invention using a microprocessor card.

### DETAILED DESCRIPTION OF EMBODIMENTS OF THE INVENTION

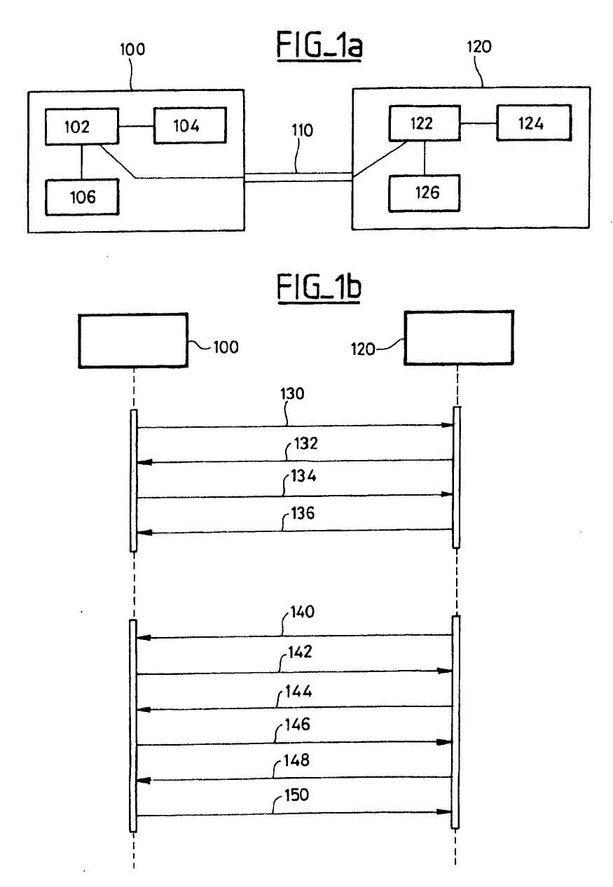

FIG. 1a diagrammatically represents an embodiment of the invention, which is then detailed by the description of a number of other embodiments. Thus, as represented in FIG. 1a, there are provided content distribution means that include a content server 100 using a DRM method, called the DRM server 100.

This server 100 is linked, in particular during content transfers, via digital connection means (comprising in this embodiment a two-way digital bus 110), to a portable multimedia player 120 serving as the consuming device.

According to the invention, a reliable time reference, called the true date, is available on the server 100 through a secured clock 104.

This true date is sent to the consuming device and can be used in accordance with two embodiments (which can be combined).

One of these embodiments involves verifying the limit date (and therefore the allotted time) of each content stored in the consuming device, once the true date is known to the latter.

The other of these embodiments involves verifying the value of the internal clock 124 of the portable multimedia player 120, called internal date, and comparing it with the true date. This second embodiment can include, in a variant, a processing of associated event files or registers that record, for example, any modification of the clock of the portable player not attributable to simple elapsed time.

The DRM server 100 includes a storage unit 106 storing a content having a consumption limit date. The content has an allotted access time, this time being the period of time between an initial consumption authorization date, for example, the date of transfer of the content to the portable player 120, and a consumption limit date. The content is called content with limited access time. This DRM server 100 is identified by data called the DID identifier. It holds:
a key denoted S_{D} used to authenticate the true date,
an authentication algorithm denoted AuthAlgo1, used in association with the key S_{D} to obtain authentication information AuthInfo,
an authentication algorithm AuthAlgo2 that is used to create licence authentication data denoted AuthLicence,
a diversification algorithm DIVAlgo,
a key L_{A} used to create AuthLicence data,
a key L_{V} used to create AuthLicence data obtained by the formula:

AuthLicence=AuthAlgo2{L_{V}}(Licence).

Lv is obtained by: Lv=DIVAlgo{L_{A}}(CID, PID).

It will be noted that, throughout the description, the notation Result=Algo{K}(Data) means that an algorithm or a function denoted Algo is applied to Data with a parameter K (normally a cryptographic key) to obtain the Result.

The DRM server 100 manages the true date using its secured clock and it transmits it in a secured way to the portable multimedia player 120 when it is connected to the latter, in particular during a transfer of a content with limited access time with its associated licence to the portable multimedia player.

The transfer of the content with limited access time, its associated licence and the true date, from the DRM server 100 to the portable multimedia player 120, is performed via connection means. In this embodiment, the connection means comprise the digital bus 110.

In other embodiments, the connection means comprise intermediate electronic network management devices (for example, routers or network gateways).

The portable multimedia player 120 includes a storage unit 126 storing the contents with limited access time and their associated licences and a secured processor 122.

This portable multimedia player 120, identified by an identifier PID holds:
DRM software, associated with the secured processor 122, which manages the contents with limited access time and their associated licences,
a key S_{P} used to verify the authenticity of the authentication information AuthInfo sent by the DRM server 100,
a verification algorithm VerAlgo1 that is used by the portable player to validate or not validate the AuthInfo information,
a verification algorithm VerAlgo2 that is used by the portable player to determine if a licence is valid,
a key Lv used to verify the validity of a licence associated with a given content by using the VerAlgo2 algorithm according to the formula:

Valid or Invalid=VerAlgo2{Lv}(Licence, AuthLicence)

The portable multimedia player 120 includes an unsecured clock 124, that is, this clock can be modified by a user (for example, by cutting off its power supply). This portable player 120 receives the content with limited access time and its associated licence transmitted by the DRM server 100.

The content with limited access time transferred is identified by an identifier CID, contains multimedia data (audio/video) and is associated with a secured licence by its identifier CID.

A licence associated with a content with limited access time contains:
an expiry date,
an identifier CID that is used to associate it with the content with the same identifier CID,
an identifier PID that is used to associate it with a portable multimedia player 120 with the same PID,
the AuthLicence data, which is used to authenticate the content of the licence.

The portable multimedia player 120 may not have the true date in memory. Its clock 124 may have been reset or modified since the last connection to the DRM server 100. However, its secured processor 122 verifies the AuthLicence data using the VerAlgo2 algorithm and the key Lv each time the user accesses the associated content and each time a valid date is received.

If the licence has expired, the reading of the content is refused and the licence and associated content are erased. Otherwise, the secured processor 122 allows the content to be consumed.

The transmission of the true date is performed by the following steps:
Step 1: the secured processor 102 of the DRM server 100 calculates the AuthInfo information using the true date, the key S_{D} and the authentication algorithm AuthAlgo1:

AuthInfo=AuthAlgo1{S_{D}}(true date),
Step 2: the DRM server 100 sends to the portable multimedia player 120, at the same time, the true date and the AuthInfo information,
Step 3: the secured processor 122 of the portable multimedia player 120 verifies the validity of the true date received using the AuthInfo information, the true date received, the key S_{P} and the VerAlgo1 algorithm according to the formula:

Valid or Invalid=VerAlgo1{S_{P}}(true date received,AuthInfo)
Step 4: If the VerAlgo1 algorithm indicates that the allegedly true date received is valid, the secured processor of the portable multimedia player 120 updates its internal clock, otherwise, the allegedly “true” date is rejected.

In this embodiment, the general data transfer steps are described diagrammatically in FIG. 1b.

On a first transfer of a given content:

In a first step 130, on a first transfer of the content, the portable multimedia player 120 synchronizes its clock with the secured clock 104 of the DRM server 100. This synchronization can take place on each reconnection.

Then, in a step 132, the portable player 120 requests a content from the DRM server 100.

The DRM server 100 then sends it the content in a step 134.

Finally, the portable player 120 disconnects from the DRM server 100 in the step 136.

On another later connection of the portable player 120 to the DRM server 100:

In a step 140, the portable player 120 reconnects to the DRM server 100. The latter verifies, in another step 142, the consistency of certain time data of the portable player 120 (for example, the consumption limit dates of the contents having a limited access time or the value of the clock 124 internal to the portable player 120) against the true date.

Time data of the portable player 120 can be sent to the DRM server 100 (step 144).

In another embodiment, the DRM server 100 directly accesses the list of licences on the portable player 120 and deletes those that are out of date.

Then, if the time data processed is not consistent with the true date, actions (in particular sanctions against the user of the portable player 120) are ordered from the DRM server 100 to the portable player 120 in particular to prevent the consumption of the content (step 146).

Otherwise (step 148), the portable player sends a request for content which is then transferred to it in the step 150.

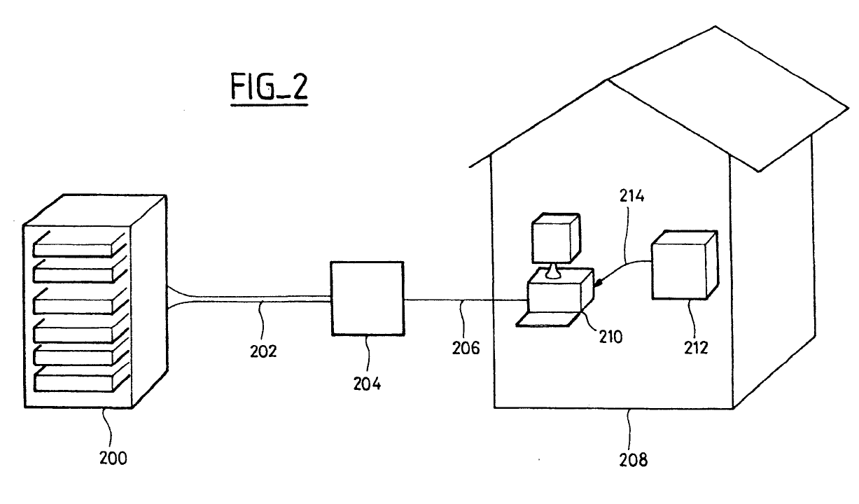

FIG. 2 diagrammatically describes a preferred embodiment of the invention:

The distribution means comprise a standard server 200 associated with DRM software. This server 200 is connected via a network 202 to a telephone exchange 204.

This telephone exchange 204 is in turn connected, via an ADSL (Asymmetric Digital Subscriber Line) line 206, to a personal computer 210 of a customer, this computer 210 acting as the device for accessing the contents of all the consuming devices of this customer.

A portable multimedia player 212 can be connected to the personal computer 210 via a USB (Universal Serial Bus) interface 214.

The key S_{D}, hereinafter denoted S, of the DRM server 200 is a private RSA key 1024 bits long. The key S_{P}, hereinafter denoted P, of the portable multimedia player 212, is the public RSA key corresponding to S.

The identifier DID of the DRM server 200 is data on 128 bits.

The identifier CID of the content is data on 128 bits.

The identifier PID of the portable player is data on 128 bits.

The key L_{A} used in encoding the licences is a secret key on 128 bits.

The key L_{V} used to authenticate and verify the licences is a secret key on 128 bits that can be obtained using the following formula:

Lv=AES{L_{A}}(CID,PID)

where AES (Advanced Encryption Standard) is a public algorithm defined by the National Institute of Standards and Technology in the United States.

In this embodiment, the AES algorithm serves as a diversification algorithm DIVAlgo defined previously.

The authentication algorithm AuthAlgo1 is the algorithm RSASSA-PSS-SIGN defined in version 2.1 of the RSA Laboratories Encoding Standard.

The verification algorithm VerAlgo1 is the algorithm RSASSA-PSS-VERIFY defined in version 2.1 of the RSA Laboratories Encoding Standard.

The authentication algorithm AuthAlgo2 is the AES encoding algorithm.

The verification algorithm VerAlgo2 is the comparison between the AuthLicence data and the result of: AES{Lv}(Licence)

In this preferred embodiment, the consumption limit date on a content with limited access time is verified, this limit date being included in the licence.

Two of the general steps described in FIG. 1b are then detailed in this embodiment:

Thus, the step 142 of FIG. 1b is, in this embodiment, the step where the DRM server verifies the consumption limit date of the licence stored in the portable player.

This consumption limit date included in the licence is then sent to the DRM server 100 in the step 144.

In a second embodiment, the portable multimedia player is directly connected to the DRM server using an ADSL digital connection line. In this embodiment, there is therefore no intermediate personal computer serving as access device.

In a third embodiment, independent of the first two, the data of the first embodiment is defined as follows:

The key S_{D}, hereinafter denoted S in the description of this embodiment, of the DRM server is a 128-bit secret key of the AES algorithm.

The key S_{P} of the portable multimedia player is the same secret 128-bit key as S.

The authentication algorithm AuthAlgo1 is the HMAC algorithm defined in publication 198 of the National Institute of Standards and Technology in the United States entitled “The Keyed-Hash Message Authentication”.

The verification algorithm VerAlgo1 is also the HMAC algorithm.

The AuthInfo data is the result obtained by applying the HMAC algorithm to the true date using the key S.

To validate the AuthInfo data, the portable multimedia player can also use the HMAC algorithm applied to the true date using the secret key S. If the values match, AuthInfo is true, otherwise it is false.

In an independent variant of this third embodiment:

The key S_{D} of the DRM server is a 128-bit secret key of the AES algorithm.

The key S_{P}, denoted S_{V} in this variant, of the portable multimedia player is a different 128-bit secret key.

Between S_{V} and S_{D}, there is a derivation relationship. S_{D} can be recalculated using the formula (1):

S_{D}=AES{S_{V}}(DID) (1)

The authentication algorithm AuthAlgo1 is the HMAC algorithm.

The verification algorithm VerAlgo1 is also the HMAC algorithm.

The AuthInfo data is the result obtained by applying the HMAC algorithm to the true date using the secret key S_{D}.

To verify the AuthInfo data, the portable multimedia player first obtains S_{D} using the formula (1). Then, it applies the HMAC algorithm to the true date using the secret key S_{D}. If the values match, the AuthInfo data is true, otherwise it is false.

A fourth embodiment is described below.

An N-hour content licence is transferred to the portable multimedia player when the latter is connected to a computer associated with DRM software, called client DRM computer. After the transfer of the content and the licence, the portable multimedia player can disconnect from the client DRM. The licence provides all the information needed to transform the digital content into an encrypted content with no right to copy (view only) if authorization is given, to be consumed in particular in a portable multimedia player.

The portable multimedia player has no secured clock. Only the client DRM computer has a reliable time reference, for example from a secured clock, which is required when implementing DRM services.

Consequently, a defrauding user can try to modify the time of the portable player so as to consume a content having rights of N hours over a longer time than that allowed.

However, when the portable multimedia player is next connected to the client DRM computer, the latter verifies the internal clock of the portable multimedia player and synchronizes it on its secured clock, for example, to delete all the invalid N-hour licences or to take other sanctions.

It is therefore necessary simply to establish a secured link between the DRM computer and the portable player to synchronize the clock.

In this embodiment, the time is controlled directly by observing the value of the clock on the portable multimedia player.

Thus, two of the general steps described in FIG. 1b are then specified in this embodiment, as follows:

The step 142 of FIG. 1b, is, in this variant, the one where the DRM server verifies the authenticity of the internal clock of the portable player.

This value of the internal clock of the portable player is then sent to the DRM computer in the step 144.

This fourth embodiment can be implemented using a microprocessor card included in the portable multimedia player. The DRM computer and the microprocessor card each contain a pair of asymmetrical keys with a certificate.

On each connection, the DRM personal computer and the card of the portable multimedia player are mutually authenticated and establish a secured link between them.

Then, the DRM personal computer reupdates the internal clock of the portable player. The latter can then update the list of the contents that it contains, deleting those that are out of date.

Advantageously, certain particular events can be stored by the card to track the time changes of the portable device.

This event file is then stored in the card. When the portable player is connected to the DRM computer, this event file is also transferred to this DRM computer, which then manages the actions to be undertaken.

In order to create this event file, the card can regularly read and store the clock of the portable player.

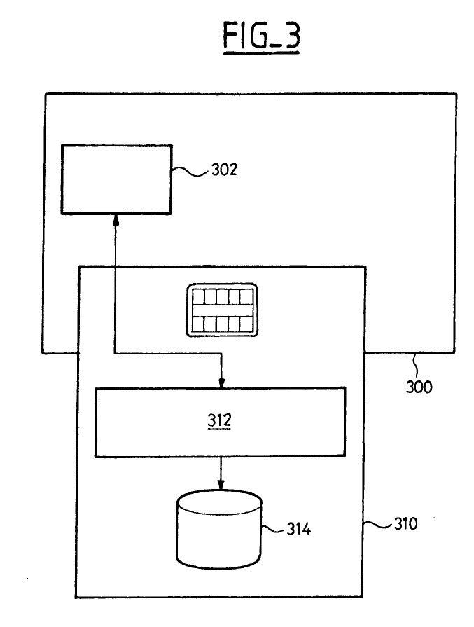

FIG. 3 is a diagrammatic representation of this storage method.

A portable player 300 includes an internal clock 302 and is associated with a card 310.

Each time the portable player accesses a content (start of consumption), the value of the clock of the portable player is recorded. This clock time value is sent to the card for signing in signature means 312 of the microprocessor card 310 provided for this purpose.

This clock time value is also compared with the expiry date of the content by the secured card 310 and it is thus possible to control that the consumption is allowed.

The card 310 always keeps (in a secured way) at least the last clock time value in the storage means or in the signature file 314.

Before allowing the consumption of the content, the microprocessor card 310 verifies that the value of the clock 302 is later than the clock time values stored previously.

If not, this may signify that the clock has been subject to a fraudulent manipulation and the card 310 refuses to allow the consumption of any protected content.

Otherwise, the card 310 verifies that the limit date of the content licence is later than the clock time value at this precise moment of the clock 302: if such is the case, the consumption of the content is allowed, otherwise it is blocked.

Advantageously, it is possible to impose the association of the card with the portable player so as to be able to adjust the clock of the portable player.

Another example of event file creation is to store in the microprocessor card only the modifications to the clock.

Advantageously, the card of the portable device can store a counter of the total consumption time of each content with limited access time.

If this counter exceeds the difference between the consumption limit date and an initial consumption date, the limit date and initial date values being defined by the N-hour licence associated with the content, the card does not supply the keys for decoding the content and thus blocks its consumption even if the value of the internal clock is prior to the limit date value.

1. A method for controlling a consumption limit date of a digital content which is transferred from distribution means to a consuming device during a temporary connection to be consumed on that device until the limit date, the distribution means having a clock, called a reference clock, the value of which at each instant is called the true date,
the method comprising the steps, each time the consuming device connects to the distribution means, of:
transmitting a signal including the true date from the distribution means to the consuming device using a secured method; and
verifying in the consuming device that the consumption limit date is not exceeded.

2. The method according to claim 1, comprising the further step, in the case where the consumption limit date has been exceeded, of blocking the consumption of this content on the consuming device, or erasing this content is erased from the consuming device.

3. The method according to claim 1, wherein the secured method of transmitting the true date includes the sending of a result of a secured digital processing of this true date by the distribution means, this result being used by reliable processing means of the consuming device to obtain the true date from the result.

4. The method according to claim 3, wherein the secured method of transmitting the true date includes the sending of the true date in plaintext associated with the sending of the result of the secured digital processing of the true date
the method further comprising a step, in the consuming device of comparing the result received with a result of the secured digital processing in the consuming device of the true date received in plaintext in order to check the authenticity of the true date.

5. The method according to claim 3, wherein a microprocessor card is used, in the consuming device to perform the secured digital processing used to check the authenticity of the true date.

6. The method according to claim 1, wherein, the consuming device having an internal clock, the value of which at each instant is called the date of the device, this internal clock of the device is synchronized with the reference clock each time the true date is received by the device.

7. The method according to claim 6, further comprising the step of storing regularly sampled values of the internal clock of the consuming device in an event file associated with the internal clock.

8. The method according to claim 7, wherein the event file is included in a microprocessor card associated with the consuming device.

9. The method according to claim 1, wherein a microprocessor card associated with the consuming device stores a time counter aggregating the consumption times of the content in order to block its consumption when the value of this counter exceeds the difference between the consumption limit date and an initial consumption date, from which the consumption of the content is authorized.

10. A consuming device intended to consume at least one digital content until a limit date, this device comprising means for receiving, on a temporary connection, this content transferred from distribution means having a clock, called a reference clock and the value of which at each instant is called the true date.
wherein said consuming device includes means for receiving, in a secured way, a signal including the true date on temporary connections to the distribution means, this true date then being used as a time reference to control that the consumption limit date of the content is not exceeded.

11. The consuming device according to claim 10, further including an internal clock and means for synchronizing its internal clock with the reference clock using the true date received.

12. The consuming device according to claim 10, wherein it is portable and can be used to consume audio and/or video contents.

13. Means for controlling the consumption of a content, these means being included in distribution means to which a consuming device is connected to receive a content in order to consume it, this consumption being possible only before a limit date, the distribution means having a clock, called a reference clock, wherein they include means for sending in a secured way the value of the reference clock, called the true date, to the consuming device each time the consuming device is connected to the distribution means.

14. Server having an internal clock (104), called a reference clock, and adapted to distribute a digital content to a consuming device on a temporary connection of this consuming device to the server, wherein the consumption of the digital content on the consuming device must be completed before a limit date
wherein the server includes means for sending in a secured way the value of the reference clock, called the true date, to the consuming device each time the consuming device is connected to the server, in order to control that the consumption limit date of the content is not exceeded.

15. Method for controlling the consumption limit date of a digital content stored in a consuming device, the consumption limit date being contained in a license stored in a secure memory of the consuming device, wherein said method comprises:
receiving a value of a reference clock, called true date, in a message transmitted securely from distribution means;
verifying the validity of the consumption limit date contained in the license stored in the secure memory with respect to the received true date; and
should said consumption limit date be exceeded, blocking the consumption of this content on the consuming device or erasing the content from the consuming device.
